(19) United States
(12) Patent Application Publication
(10) Pub. No.: US 2026/0101279 A1
(43) Pub. Date: Apr. 9, 2026

(54) POSITIONING ANCHOR SELECTION

(71) Applicant: Nokia Technologies Oy, Espoo (FI)

(72) Inventor: Stepan KUCERA, Munich (DE)

(21) Appl. No.: 18/911,155

(22) Filed: Oct. 9, 2024

Related U.S. Application Data
(63) Continuation of application No. 18/837,143.

(51) Int. Cl. H04W 48/20; G01S 5/02

(52) U.S. Cl. CPC H04W 48/20; G01S 5/0205

(57) ABSTRACT

Disclosed is a method comprising receiving, from one or more network nodes, one or more first messages indicative of being able to provide a positioning service; selecting, based at least partly on the one or more first messages, a network node from the one or more network nodes; and transmitting, to the selected network node, a second message indicating to activate the positioning service.

### RELATED APPLICATIONS

This application is a 37 C.F.R. § 1.53 (b) continuation of co-pending U.S. patent application Ser. No. 18/837,143 filed Aug. 8, 2024, which claims priority to PCT Application No. PCT/EP2022/054692, filed on Feb. 24, 2022, which is incorporated herein by reference in its entirety.

### FIELD

The following exemplary embodiments relate to wireless communication and to positioning.

### BACKGROUND

Positioning technologies may be used to estimate a physical location of a device. It is desirable to improve the positioning accuracy in order to estimate the device location more accurately.

### SUMMARY

The scope of protection sought for various exemplary embodiments is set out by the claims. The exemplary embodiments and features, if any, described in this specification that do not fall under the scope of the claims are to be interpreted as examples useful for understanding various exemplary embodiments.

According to an aspect, there is provided an apparatus comprising at least one processor, and at least one memory including computer program code, wherein the at least one memory and the computer program code are configured, with the at least one processor, to cause the apparatus to: receive, from one or more network nodes, one or more first messages indicative of being able to provide a positioning service; select, based at least partly on the one or more first messages, a network node from the one or more network nodes; and transmit, to the selected network node, a second message indicating to activate the positioning service.

According to another aspect, there is provided an apparatus comprising means for: receiving, from one or more network nodes, one or more first messages indicative of being able to provide a positioning service; selecting, based at least partly on the one or more first messages, a network node from the one or more network nodes; and transmitting, to the selected network node, a second message indicating to activate the positioning service.

According to another aspect, there is provided a method comprising: receiving, from one or more network nodes, one or more first messages indicative of being able to provide a positioning service; selecting, based at least partly on the one or more first messages, a network node from the one or more network nodes; and transmitting, to the selected network node, a second message indicating to activate the positioning service.

According to another aspect, there is provided a computer program product comprising program instructions which, when run on a computing apparatus, cause the computing apparatus to perform at least the following: receiving, from one or more network nodes, one or more first messages indicative of being able to provide a positioning service; selecting, based at least partly on the one or more first messages, a network node from the one or more network nodes; and transmitting, to the selected network node, a second message indicating to activate the positioning service.

According to another aspect, there is provided a computer program comprising instructions for causing an apparatus to perform at least the following: receiving, from one or more network nodes, one or more first messages indicative of being able to provide a positioning service; selecting, based at least partly on the one or more first messages, a network node from the one or more network nodes; and transmitting, to the selected network node, a second message indicating to activate the positioning service.

According to another aspect, there is provided a computer readable medium comprising program instructions for causing an apparatus to perform at least the following: receiving, from one or more network nodes, one or more first messages indicative of being able to provide a positioning service; selecting, based at least partly on the one or more first messages, a network node from the one or more network nodes; and transmitting, to the selected network node, a second message indicating to activate the positioning service.

According to another aspect, there is provided a non-transitory computer readable medium comprising program instructions for causing an apparatus to perform at least the following: receiving, from one or more network nodes, one or more first messages indicative of being able to provide a positioning service; selecting, based at least partly on the one or more first messages, a network node from the one or more network nodes; and transmitting, to the selected network node, a second message indicating to activate the positioning service.

According to another aspect, there is provided an apparatus comprising at least one processor, and at least one memory including computer program code, wherein the at least one memory and the computer program code are configured, with the at least one processor, to cause the apparatus to: transmit a first message indicative of being able to provide a positioning service; and receive, in response to the first message, a second message indicating to activate the positioning service.

According to another aspect, there is provided an apparatus comprising means for: transmitting a first message indicative of being able to provide a positioning service; and receiving, in response to the first message, a second message indicating to activate the positioning service.

According to another aspect, there is provided a method comprising: transmitting a first message indicative of being able to provide a positioning service; and receiving, in response to the first message, a second message indicating to activate the positioning service.

According to another aspect, there is provided a computer program comprising instructions for causing an apparatus to perform at least the following: transmitting a first message indicative of being able to provide a positioning service; and receiving, in response to the first message, a second message indicating to activate the positioning service.

According to another aspect, there is provided a computer program product comprising program instructions which, when run on a computing apparatus, cause the computing apparatus to perform at least the following: transmitting a first message indicative of being able to provide a positioning service; and receiving, in response to the first message, a second message indicating to activate the positioning service.

According to another aspect, there is provided a computer readable medium comprising program instructions for causing an apparatus to perform at least the following: transmitting a first message indicative of being able to provide a positioning service; and receiving, in response to the first message, a second message indicating to activate the positioning service.

According to another aspect, there is provided a non-transitory computer readable medium comprising program instructions for causing an apparatus to perform at least the following: transmitting a first message indicative of being able to provide a positioning service; and receiving, in response to the first message, a second message indicating to activate the positioning service.

According to another aspect, there is provided an apparatus comprising at least one processor, and at least one memory including computer program code, wherein the at least one memory and the computer program code are configured, with the at least one processor, to cause the apparatus to: transmit one or more first signals based on at least two of: a first set of measurement information associated with a radio channel between the apparatus and a terminal device, a second set of measurement information associated with a radio channel between the terminal device and one or more serving anchors of the terminal device, and/or a third set of measurement information associated with a radio channel between the apparatus and the one or more serving anchors.

According to another aspect, there is provided an apparatus comprising means for: transmitting one or more first signals based on at least two of: a first set of measurement information associated with a radio channel between the apparatus and a terminal device, a second set of measurement information associated with a radio channel between the terminal device and one or more serving anchors of the terminal device, and/or a third set of measurement information associated with a radio channel between the apparatus and the one or more serving anchors.

According to another aspect, there is provided a method comprising: transmitting one or more first signals based on at least two of: a first set of measurement information associated with a radio channel between the apparatus and a terminal device, a second set of measurement information associated with a radio channel between the terminal device and one or more serving anchors of the terminal device, and/or a third set of measurement information associated with a radio channel between the apparatus and the one or more serving anchors.

According to another aspect, there is provided a computer program comprising instructions for causing an apparatus to perform at least the following: transmitting one or more first signals based on at least two of: a first set of measurement information associated with a radio channel between the apparatus and a terminal device, a second set of measurement information associated with a radio channel between the terminal device and one or more serving anchors of the terminal device, and/or a third set of measurement information associated with a radio channel between the apparatus and the one or more serving anchors.

According to another aspect, there is provided a computer program product comprising program instructions which, when run on a computing apparatus, cause the computing apparatus to perform at least the following: transmitting one or more first signals based on at least two of: a first set of measurement information associated with a radio channel between the apparatus and a terminal device, a second set of measurement information associated with a radio channel between the terminal device and one or more serving anchors of the terminal device, and/or a third set of measurement information associated with a radio channel between the apparatus and the one or more serving anchors.

According to another aspect, there is provided a computer readable medium comprising program instructions for causing an apparatus to perform at least the following: transmitting one or more first signals based on at least two of: a first set of measurement information associated with a radio channel between the apparatus and a terminal device, a second set of measurement information associated with a radio channel between the terminal device and one or more serving anchors of the terminal device, and/or a third set of measurement information associated with a radio channel between the apparatus and the one or more serving anchors.

According to another aspect, there is provided a non-transitory computer readable medium comprising program instructions for causing an apparatus to perform at least the following: transmitting one or more first signals based on at least two of: a first set of measurement information associated with a radio channel between the apparatus and a terminal device, a second set of measurement information associated with a radio channel between the terminal device and one or more serving anchors of the terminal device, and/or a third set of measurement information associated with a radio channel between the apparatus and the one or more serving anchors.

According to another aspect, there is provided a system comprising at least a terminal device and one or more network nodes of a wireless communication network. The one or more network nodes are configured to: transmit, to the terminal device, one or more first messages indicative of being able to provide a positioning service. The terminal device is configured to: receive, from the one or more network nodes, the one or more first messages; select, based at least partly on the one or more first messages, a network node from the one or more network nodes; and transmit, to the selected network node, a second message indicating to activate the positioning service.

According to another aspect, there is provided a system comprising at least a terminal device and one or more network nodes of a wireless communication network. The one or more network nodes comprise means for: transmitting, to the terminal device, one or more first messages indicative of being able to provide a positioning service. The terminal device comprises means for: receiving, from the one or more network nodes, the one or more first messages; selecting, based at least partly on the one or more first messages, a network node from the one or more network nodes; and transmitting, to the selected network node, a second message indicating to activate the positioning service.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIGS. 2a and 2b illustrate geometric dilution of precision error with ideally distributed anchors;

FIGS. 3a and 3b illustrate anchor selection;

FIGS. 4a, 4b and 4c illustrate different types of geometric modelling of an ideal or suitable activation sector;

FIG. 5 illustrates a signaling diagram according to an exemplary embodiment;

FIG. 6 illustrates a signaling diagram according to an exemplary embodiment;

FIG. 7 illustrates a signaling diagram according to an exemplary embodiment;

FIG. 8 illustrates a signaling diagram according to an exemplary embodiment;

FIG. 9 illustrates a signaling diagram according to an exemplary embodiment;

FIG. 10 illustrates a flow chart according to an exemplary embodiment;

FIG. 11 illustrates a flow chart according to an exemplary embodiment;

FIG. 12 illustrates a flow chart according to an exemplary embodiment;

FIG. 13 illustrates a flow chart according to an exemplary embodiment;

FIG. 14 illustrates examples of possible geometric transformations of channel measurements performed by a candidate anchor;

FIG. 15 illustrates an example of combining multiple geometric criteria;

FIG. 16 illustrates an apparatus according to an exemplary embodiment; and

FIG. 17 illustrates an apparatus according to an exemplary embodiment.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A), new radio (NR, 5G), beyond 5G, or sixth generation (6G) without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management 1 functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

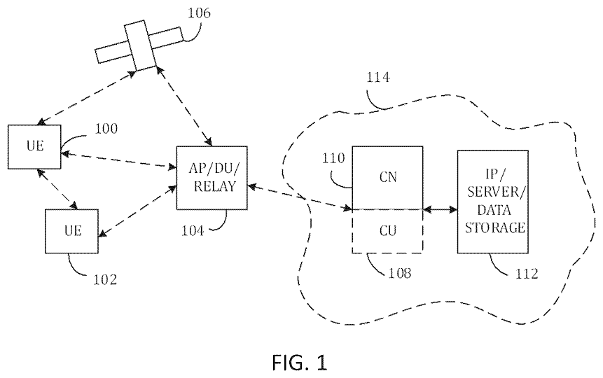

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node 104, such as an evolved Node B (abbreviated as eNB or eNodeB) or a next generation Node B (abbreviated as gNB or gNodeB), providing the cell. The physical link from a user device to an access node may be called uplink or reverse link, and the physical link from the access node to the user device may be called downlink or forward link. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes. The access node may be a computing device configured to control the radio resources of communication system it is coupled to. The access node may also be referred to as a base station, an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to core network 110 (CN or next generation core NGC). Depending on the system, the counterpart on the CN side may be a serving gateway (S-GW, routing and forwarding user data packets), packet data network gateway (P-GW) for providing connectivity of user devices to external packet data networks, user plane function (UPF), mobility management entity (MME), access and mobility management function (AMF), or location management function (LMF), etc.

The user device illustrates one type of an apparatus to which resources on the air interface may be allocated and assigned, and thus any feature described herein with a user device may be implemented with a corresponding apparatus, such as a relay node. The user device may also be called a subscriber unit, mobile station, remote terminal, access terminal, user terminal, terminal device, or user equipment (UE) just to mention but a few names or apparatuses.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud. The user device (or in some exemplary embodiments a layer 3 relay node) may be configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHZ—cmWave—mm Wave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and base station operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the base station or access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IOT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of access nodes, the user device may have an access to a plurality of radio cells and the system may also comprise other apparatuses, such as physical layer relay nodes or other network elements, etc. At least one of the access nodes may be a Home eNodeB or a Home gNodeB.

Furthermore, the access node may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the access node. The DU may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio system may be implemented as a multilayer network including several kinds of cells. In multilayer networks, one access node may provide one kind of a cell or cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

Positioning technologies may be used to estimate a physical location of a device such as a UE. For example, the following positioning techniques may be used in NR: downlink time difference of arrival (DL-TDoA), uplink time difference of arrival (UL-TDoA), downlink angle of departure (DL-AoD), uplink angle of arrival (UL-AoA), and/or multi-cell round trip time (multi-RTT). The positioning may be based on one or more positioning reference signals (PRS). For example, the sounding reference signal (SRS) is a positioning reference signal that may be used for positioning in the uplink (UL). It should be noted that SRS may also be used for other purposes than positioning.

In wireless positioning, multiple positioning anchors in known locations may transmit one or more signals (e.g., PRS) to, or receive one or more signals (e.g., SRS) from, a target UE in an unknown location. Multilateration techniques may then be used to localize (i.e., position) the target UE with respect to the anchors. The positioning anchors may also be referred to as anchors, multilateration anchors, or reference points herein. For example, another UE or an access node (e.g., gNB) of a wireless communication network may be used as an anchor.

In sidelink positioning, the target UE may be positioned by transmitting one or more sidelink positioning reference signals (S-PRS) to one or more anchor UEs, and/or by receiving one or more S-PRS from the one or more anchor UEs.

The achievable accuracy of positioning the target UE may depend on how the anchors are distributed around the target UE. Ideally, the anchors would be distributed uniformly around the target UE. The error due to geometric dilution of precision (GDOP) is the lowest, if the neighboring anchors have an angular separation of 360 degrees divided by N, where N is the total number of active anchors.

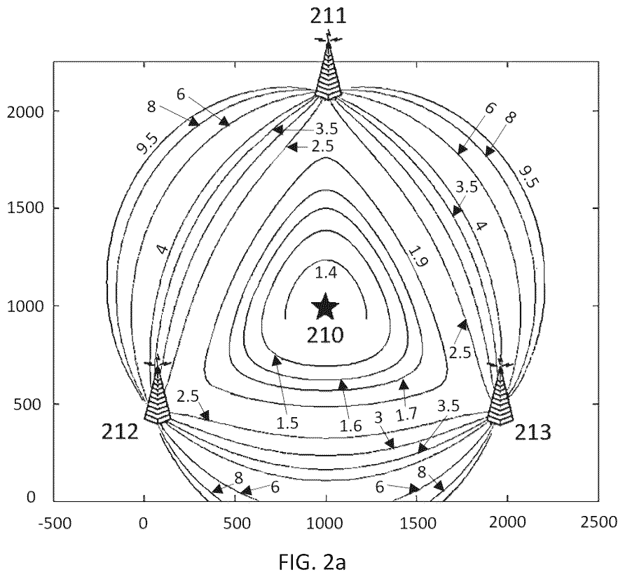

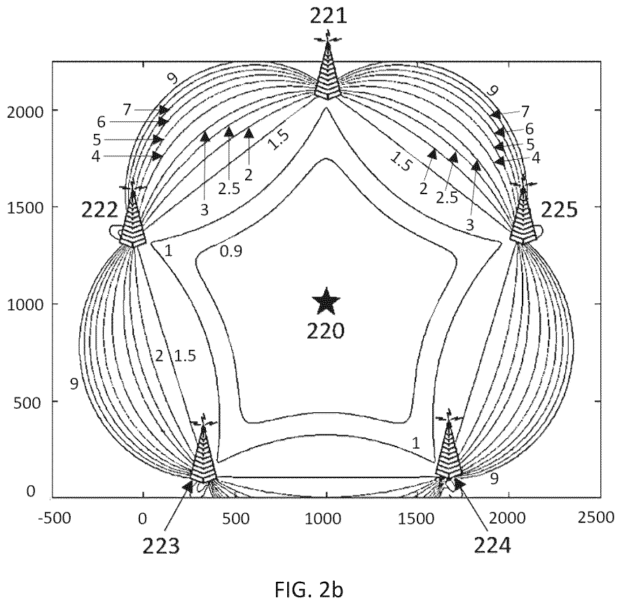

FIGS. 2a and 2b illustrate GDOP error, when positioning a target UE with ideally distributed anchors. In FIGS. 2a and 2b, the values in the horizontal and vertical axes (x axis and y axis) indicate distance in meters. The other values within FIGS. 2a (e.g., 1.4, 1.5, . . . , 9.5) and 2b (e.g., 0.9, 1, . . . , 9) indicate the magnitude of GDOP error.

FIG. 2a illustrates an example of positioning a target UE 210 with three ideally distributed anchors 211, 212, 213. In the example of FIG. 2a, the angular separation may be 360°/3=120°.

FIG. 2b illustrates an example of positioning a target UE 220 with five ideally distributed anchors 221, 222, 223, 224, 225. In the example of FIG. 2b, the angular separation may be 360°/5=72°.

It should be noted that the number of anchors may also differ from what is shown in FIGS. 2a and 2b.

In a mobile time-varying (sidelink) topology with multiple positioning anchors available, there is a challenge in how to select, with zero signaling overhead and no prior topology knowledge, positioning anchors that provide the best possible positioning accuracy. The selection may be performed by the target UE or any other decision-making node, such as a base station or LMF. The challenge can alternatively be formulated as how to optimally select the lowest number of anchors that provide the maximum or at least a pre-defined accuracy.

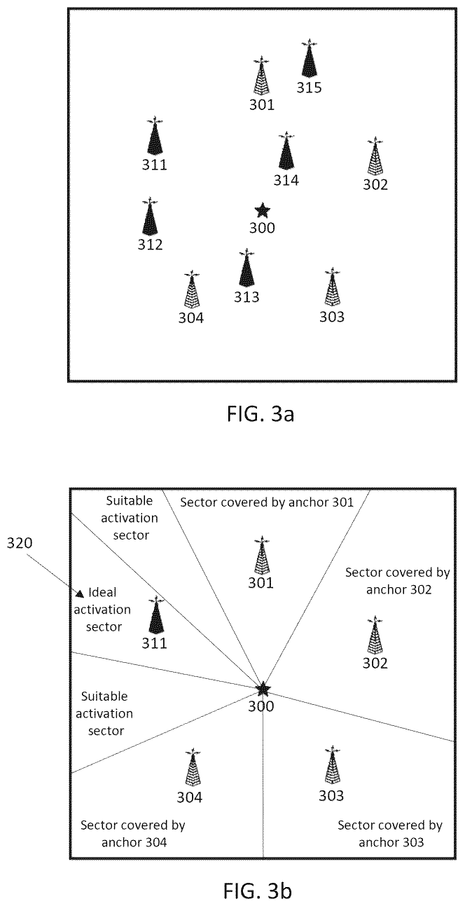

FIG. 3a illustrates the anchor-selection problem by showing a network, in which four serving anchors 301, 302, 303, 304 are already providing a positioning service to a target UE 300. For example, the positioning service may mean PRS transmission and SRS reception for the multi-RTT positioning technique.

The question is then where to activate a fifth anchor that would further reduce the overall GDOP in the system. In other words, to further improve positioning accuracy, the fifth anchor is to be activated to the network from the set of candidate anchors 311, 312, 313, 314, 315.

It should be noted that the number of candidate anchors and serving anchors may also differ from what is shown in FIG. 3a.

FIG. 3b illustrates an example for selecting the fifth anchor for the network shown in FIG. 3a. From FIG. 3b, it can be seen that the candidate anchor 311 is the most suitable choice, as it lies in the center of the sector 320 with the lowest GDOP (see FIG. 2b). In other words, activating the candidate anchor 311 achieves the highest maximum angular separation from the neighboring serving anchors 301, 302, 303, 304, and thus the best improvement of GDOP among the available candidate anchors. Activating any other candidate anchor may not contribute as much to lower the GDOP, as at least some of the other candidate anchors may be located in sectors already covered by the active serving anchors 301, 302, 303, 304. Activating candidate anchors in the already covered sectors may be practically useless and should be avoided, since they would basically just duplicate the positioning service of the existing serving anchors. However, currently there may be no mechanism for determining the ideal sector 320 for activating a candidate anchor.

The term “candidate anchor” may be used herein to refer to a network node (e.g., UE or access node) that is able to provide a positioning service to the target UE, but the positioning service is not currently provided by that node. In other words, the candidate anchors are not currently transmitting PRS. On the other hand, the term “serving anchor” may be used herein to refer to a network node (e.g., UE or access node) that is actively providing a positioning service (e.g., transmitting PRS that is received and measured by the target UE).

Some exemplary embodiments provide a fast and efficient mechanism for determining whether a candidate anchor is in an ideal or suitable activation sector, without requiring any particular assumptions on topology knowledge or directive antenna measurements. In other words, some exemplary embodiments enable determining whether a candidate anchor would, upon future activation, productively complement the positioning service already offered by the existing serving anchors. In this way, the activation of duplicate anchors in co-located or poorly separated positions with regard to the existing serving anchors may be avoided.

Omni-directional channel measurements may be used as a basis for determining, or approximating, the ideal or suitable activation sector. For example, the ideal or suitable activation sector may be determined based on channel gain or received power measurements between at least two of the three types of nodes: the target UE, one or more serving anchors, and/or one or more candidate anchors. These measurements may be a priori known to the relevant network nodes (e.g., from the actual positioning measurements), and thus no additional signaling overhead may be caused by obtaining the measurements.

By using geometric transformations of the channel measurements, the decision-making node may then check if a given candidate anchor is located inside of the ideal or suitable activation sector (e.g., the ideal sector 320 of FIG. 3b). Thus, no extra signaling overhead, antenna directivity, beamforming capability or any other similar assumptions may be required.

More specifically, a decision-making node (e.g., the target UE, candidate anchor, or serving anchor) may evaluate certain activation criteria based on geometric inequalities indicated by the channel measurements. These criteria may be fulfilled, when the candidate anchor is located in an ideal or suitable activation sector (e.g., the ideal sector 320 of FIG. 3b) based on the geometric transformations of the channel measurements.

Optionally, the presence of the candidate anchor in the ideal or suitable activation sector may be confirmed based on the satisfaction of a possibly composite criterion combining several geometric criteria for the channel measurements. This task may be distributed to multiple decision-making nodes (e.g., target UE and/or candidate anchor) to allow for practical adaptability.

Three different approaches to the modelling of the ideal or suitable activation sector are described in the following, each reflecting different types of channel measurements available to the network nodes (e.g., reflecting different network and decision-making configurations).

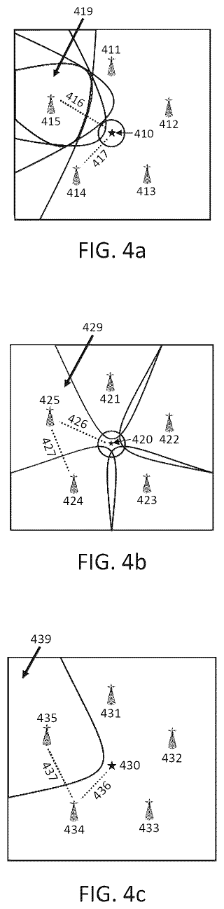

FIGS. 4a, 4b, and 4c illustrate three types of geometric modelling of the ideal or suitable activation sector, each reflecting different types of channel measurements available.

FIG. 4a illustrates an example for a target UE centric approach. In this example, channel measurements from a target UE 410 to a candidate anchor 415 and to one or more serving anchors 411, 412, 413, 414 are utilized. The channel measurements comprise a set of measurement information associated with a radio channel 416 between the target UE 410 and the candidate anchor 415, as well as a set of measurement information associated with a radio channel 417 between the target UE 410 and the one or more serving anchors 411, 412, 413, 414.

The sets of measurement information may indicate channel gain. For example, the sets of measurement information may comprise measured values for one or more metrics, such as received power, signal-to-noise ratio (SNR), signal-to-interference-plus-noise ratio (SINR), and/or any metric related to distance and/or signal time-of-flight. The channel gain may be a function of distance and path loss.

In the target UE centric approach, the criteria for activating the candidate anchor 415 may be based on geometric shapes, whose focal points are formed by the candidate anchor 415 and the one or more serving anchors 411, 412, 413, 414. The ideal or suitable activation sector 419 may be modelled based on an intersection of multiple inclusion areas (e.g., of hyperbolic type).

FIG. 4b illustrates an example for a candidate anchor centric approach. In this example, channel measurements from a candidate anchor 425 to the target UE 420 and to one or more serving anchors 421, 422, 423, 424 are utilized. The channel measurements comprise a set of measurement information associated with a radio channel 426 between the candidate anchor 425 and the target UE 420, as well as a set of measurement information associated with a radio channel 427 between the candidate anchor 425 and the one or more serving anchors 421, 422, 423, 424.

The sets of measurement information may indicate channel gain. For example, the sets of measurement information may comprise measured values for one or more metrics, such as received power, SNR, SINR, and/or any metric related to distance and/or signal time-of-flight.

In the candidate anchor centric approach, the criteria for activating the candidate anchor 425 may be based on geometric shapes, whose focal points are formed by the target UE 420 and the one or more serving anchors 421, 422, 423, 424. The ideal or suitable activation sector 429 may be modelled based on a union of multiple exclusion areas (e.g., of hyperbolic type), wherein the exclusion areas comprise the areas already covered by the one or more serving anchors 421, 422, 423, 424.

FIG. 4c illustrates an example for a serving anchor centric approach. In this example, channel measurements from a serving anchor 434 to the target UE 430 and to one or more candidate anchors 435 are utilized. The channel measurements comprise a set of measurement information associated with a radio channel 436 between the serving anchor 434 and the target UE 430, as well as a set of measurement information associated with a radio channel 437 between the serving anchor 434 and the one or more candidate anchors 435.

The sets of measurement information may indicate channel gain. For example, the sets of measurement information may comprise measured values for one or more metrics, such as received power, SNR, SINR, and/or any metric related to distance and/or signal time-of-flight.

The serving anchor centric approach is based on checking whether the existing serving anchors 431, 432, 433, 434 are located outside of the geometric area (hyperbolic example in FIG. 4c), whose focal points are defined based on the target UE 430 and the candidate anchor 435. The ideal or suitable activation sector 439 may be modelled based on a single inclusion area (e.g., of hyperbolic type).

The examples of FIGS. 4a, 4b, and 4c assume hyperbolic models as the geometric criteria for activating the candidate anchor. However, it should be noted that other models, such as elliptic, circular, or semi-planar models may alternatively be used as the geometric criteria. Furthermore, it should be noted that the number of serving anchors and candidate anchors may also differ from what is shown in FIGS. 4a, 4b, and 4c.

To explain the concept in more detail, an example under the candidate anchor centric approach of FIG. 4b is presented in the following. In this example, it is assumed that the candidate anchor 425 activates its positioning service as the fifth anchor of the target UE, if the candidate anchor 425 lies outside of the exclusion area already covered by four pre-existing serving anchors 421, 422, 423, 424. According to this example, the exclusion area may be defined as the union:

$${( H\_C : {S}_{i} / {a}_{i} )}^{2} {( H\_C : T / {b}_{i} )}^{2} = 1 for all i and H\_C : {S}_{i} > H\_C : T$$

of hyperbolic inequalities for parameters denoted as aᵢ and bᵢ based on the local channel gain measurements by the candidate anchor 425. Using narrower hyperboles, i.e., smaller values for the parameters aᵢ and bᵢ, allows identifying sectors with higher GDOP.

H_C:Sᵢ denotes the channel gain between the candidate anchor (denoted as C) and the i-th active serving anchor (denoted as Sᵢ) of the target UE. For example, H_C:Sᵢ may be derived by the candidate anchor from the received signal strength of an ongoing PRS broadcast from the i-th serving anchor.

H_C:T denotes the channel gain between the candidate anchor (denoted as C) and the target UE (denoted as T). For example, H_C:T may be derived by the candidate anchor from the received signal strength of a positioning request message or any other transmission from the target UE.

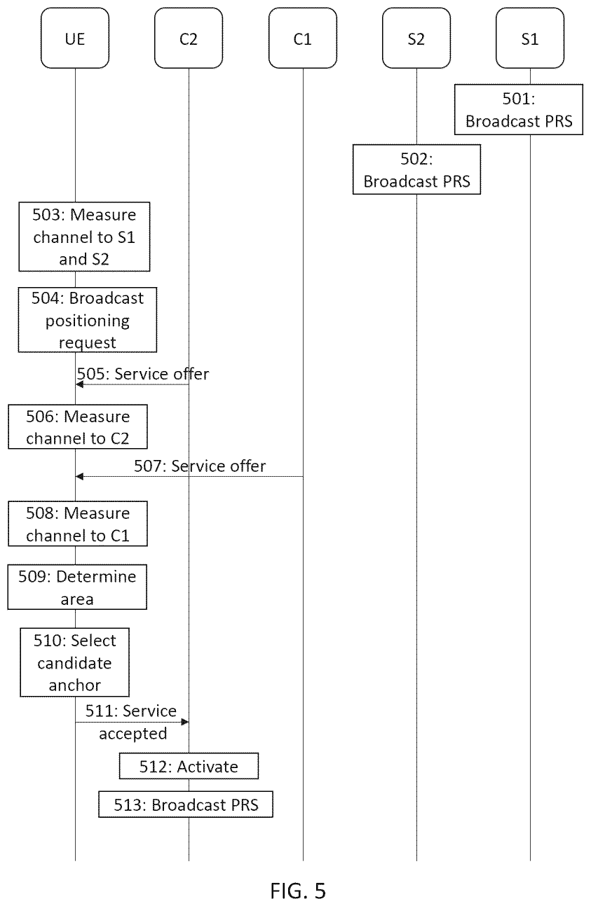

FIG. 5 illustrates a signaling diagram according to an exemplary embodiment for the target UE centric approach (see FIG. 4a). Two serving anchors S1 and S2 and two candidate anchors C1 and C2 are illustrated as an example in FIG. 5. However, it should be noted that the number of serving anchors and the number of candidate anchors may also differ from what is shown in FIG. 5. In other words, there may be one or more serving anchors and one or more candidate anchors. In addition, the signalling procedure illustrated in FIG. 5 may be extended and applied according to the number of the candidate and/or the serving anchors. The one or more serving anchors and the one or more candidate anchors may also be referred to as network nodes herein.

The two serving anchors S1 and S2 are already providing the positioning service in the network and keep broadcasting PRS. An additional anchor is to be activated to reduce GDOP error and improve positioning accuracy for positioning the target UE. Two candidate anchors C1 and C2 are available to this end.

Referring to FIG. 5, in step 501, the first serving anchor (S1) transmits, or broadcasts, one or more positioning reference signals.

In step 502, the second serving anchor (S2) transmits, or broadcasts, one or more positioning reference signals.

In step 503, the target UE measures the one or more positioning reference signals transmitted by the first serving anchor to obtain measurement information associated with the radio channel between the target UE and the first serving anchor. Furthermore, the target UE measures the one or more positioning reference signals transmitted by the second serving anchor to obtain measurement information associated with the radio channel between the target UE and the second serving anchor. The target UE may also position itself based on the two (or more) active serving anchors by measuring the PRS transmitted from them.

The measurement information associated with the radio channels between the target UE and the serving anchors may also be referred to as a second set of measurement information herein. The second set of measurement information may indicate channel gain between the target UE and the first serving anchor, as well as between the target UE and the second serving anchor. For example, the second set of measurement information may comprise measured values for one or more metrics, such as received power, SNR, SINR, and/or any metric related to distance and/or signal time-of-flight. The channel gain may be a function of distance and path loss.

In step 504, the target UE transmits, or broadcasts, a positioning request message indicating a request for positioning assistance. Alternatively, the positioning request message for positioning the target UE may be transmitted by a network node or some other UE instead of the target UE itself, in which case the target UE may transmit another transmission instead of the positioning request message.

In step 505, in response to receiving the positioning request message, the second candidate anchor (C2) transmits a service offer message to the target UE to accept the positioning request. The service offer message indicates that the second candidate anchor is able to provide a positioning service to the target UE. Alternatively, instead of an explicit service offer message, the second candidate anchor may transmit some other message, for example a set of measurements, that implicitly indicates that the second candidate anchor is able to provide the positioning service. The service offer message or the implicit message may also be referred to as a first message herein.

In step 506, the target UE obtains, based at least partly on the first message received from the second candidate anchor, measurement information associated with the radio channel between the target UE and the second candidate anchor. In other words, the target UE may measure the received signal comprising the first message from the second candidate anchor in order to obtain the measurement information.

In step 507, in response to receiving the positioning request message, the first candidate anchor (C1) transmits a service offer message to the target UE to accept the positioning request. The service offer message indicates that the second candidate anchor is able to provide a positioning service to the target UE. Alternatively, instead of an explicit service offer message, the first candidate anchor may transmit some other message, for example a set of measurements, that implicitly indicates that the first candidate anchor is able to provide the positioning service. The service offer message or the implicit message may also be referred to as a first message herein.

In step 508, the target UE obtains, based at least partly on the first message received from the first candidate anchor, measurement information associated with the radio channel between the target UE and the first candidate anchor. In other words, the target UE may measure the received signal comprising the first message from the first candidate anchor in order to obtain the measurement information.

The measurement information associated with the radio channels between the target UE and the candidate anchors may also be referred to as a first set of measurement information herein. The first set of measurement information may indicate channel gain between the target UE and the first candidate anchor, as well as between the target UE and the second candidate anchor. For example, the first set of measurement information may comprise measured values for one or more metrics, such as received power, SNR, SINR, and/or any metric related to distance and/or signal time-of-flight. The channel gain may be a function of distance and path loss.

In step 509, the target UE determines an area based on at least the first set of measurement information (between the target UE and the candidate anchors) and the second set of measurement information (between the target UE and the serving anchors). The determined area may be used to identify one or more suitable (valid) candidate anchors for activation. In other words, the one or more suitable (valid) candidate anchors may refer to candidate anchors that fulfil one or more geometric criteria. For example, the target UE may use hyperbolic approximation of the suitable/ideal activation sector as the geometric criterion. The hyperbolic criterion may be repeated iteratively for various input parameters to identify an activation sector with higher or lower GDOP.

For example, the determined area may comprise an inclusion area with higher GDOP, wherein the inclusion area is not covered by the active serving anchors. As a non-limiting example, the target UE may identify one or more valid candidate anchors located inside of the intersection of all hyperboles having the serving anchors and the candidate anchors as focal points, for example:

$${f ( H\_T : {S}_{i} )}^{2} - {f ( H\_T : {C}_{j} )}^{2} = 1 for all i and j and H\_T : {S}_{i} < H\_T : {C}_{j}$$

where H_T:Sᵢ is the channel gain between the target UE and the i-th serving anchor, and H_T:Cⱼ is the channel gain between the target UE and the j-th candidate anchor. A wrapper function f( ) may be used to convert channel gain to distance, for example based on an exponential path loss model H=d^{-a} for a>2, where d denotes distance. The wrapper function may alternatively represent conversion between logarithmic and linear scales.

As another example, the determined area may comprise an exclusion area with lower GDOP, wherein the exclusion area is already covered by the active serving anchors based on the second set of measurement information.

In step 510, the target UE selects, based at least partly on the determined area, a candidate anchor from the set of available candidate anchors.

For example, if the determined area comprises an inclusion area, then the target UE may select a candidate anchor that is inside the determined area (inclusion area). If multiple candidate anchors are identified to be inside the determined area (inclusion area), then the target UE may, for example, randomly select one candidate anchor from the multiple candidate anchors.

As another example, if the determined area comprises an exclusion area, then the target UE may select a candidate anchor that is outside of the exclusion area. If multiple candidate anchors are identified to be outside of the exclusion area, then the target UE may, for example, randomly select one candidate anchor from the multiple candidate anchors.

As an additional criterion for the selection, the target UE may also require some minimal distance from each candidate anchor. For example, the candidate anchor may be selected based at least partly on a pre-defined range for a metric associated with the radio channel between the target UE and a given candidate anchor. The metric may be, for example, channel gain, received power, SNR, SINR, distance, time-of-flight or some other metric indicated by the first set of measurement information. As a non-limiting example, the range may be represented by a maximum limit on the channel gain between the target UE and the candidate anchor, wherein the lower limit may be zero, for example. The maximum limit for the channel gain may then be used as a subsequent criterion to narrow down the selection from the set of valid candidate anchors.

In step 511, the target UE transmits a service accepted message to the selected candidate anchor (e.g., the second candidate anchor). The service accepted message indicates the selected candidate anchor to activate its positioning service (e.g., to transmit PRS). The service accepted message may also be referred to as a second message herein.

In step 512, the selected candidate anchor activates its positioning service in response to receiving the service accepted message. In other words, the selected candidate anchor becomes the third serving anchor.

In step 513, the selected candidate anchor transmits, or broadcasts, one or more positioning reference signals upon activating the positioning service.

The target UE may then position itself based on the three active serving anchors by measuring the PRS transmitted from them.

It should be noted that at least a part of the process illustrated in FIG. 5 may be performed iteratively to activate additional serving anchors. If no suitable candidate anchors are found, then no candidate anchor may be selected and the process may end.

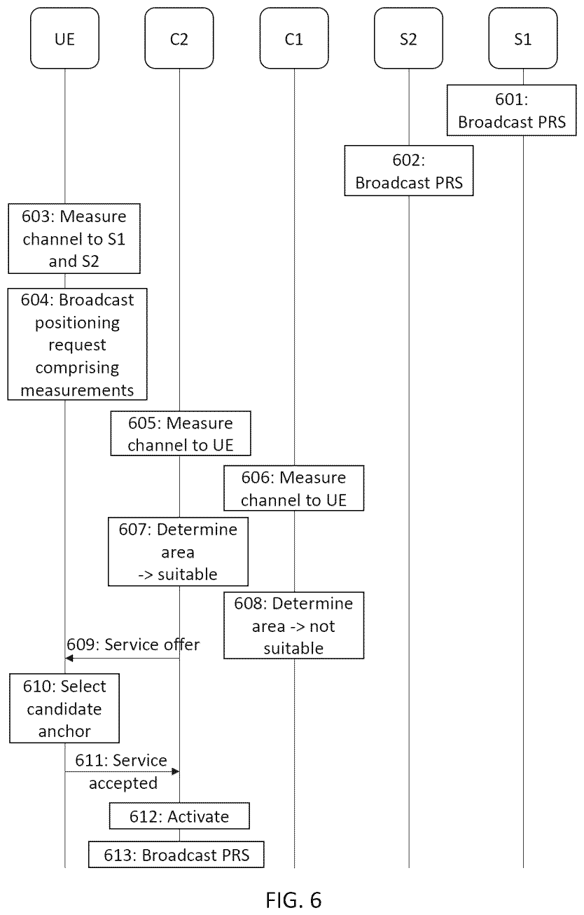

FIG. 6 illustrates a signaling diagram according to another exemplary embodiment for the target UE centric approach (see FIG. 4a). This exemplary embodiment is similar to the one above described with reference to FIG. 5, except here it is not the target UE that determines whether a candidate anchor lies in the suitable/ideal activation sector. Instead, the candidate anchors determine whether they are in the suitable/ideal activation sector, and transmit a service offer to the target UE if they are in the suitable/ideal activation sector.

Two serving anchors S1 and S2 and two candidate anchors C1 and C2 are illustrated as an example in FIG. 6. However, it should be noted that the number of serving anchors and the number of candidate anchors may also differ from what is shown in FIG. 6. In other words, there may be one or more serving anchors and one or more candidate anchors. The one or more serving anchors and the one or more candidate anchors may also be referred to as network nodes herein.

The two serving anchors S1 and S2 are providing a positioning service in the network and keep broadcasting PRS. An additional anchor is to be activated to reduce GDOP error and improve positioning accuracy for positioning the target UE. Two candidate anchors C1 and C2 are available to this end.

Referring to FIG. 6, in step 601, the first serving anchor (S1) transmits, or broadcasts, one or more positioning reference signals.

In step 602, the second serving anchor (S2) transmits, or broadcasts, one or more positioning reference signals.

In step 603, the target UE measures the one or more positioning reference signals transmitted by the first serving anchor to obtain measurement information associated with the radio channel between the target UE and the first serving anchor. Furthermore, the target UE measures the one or more positioning reference signals transmitted by the second serving anchor to obtain measurement information associated with the radio channel between the target UE and the second serving anchor. The target UE may also position itself based on the two active serving anchors by measuring the PRS transmitted from them.

The measurement information associated with the radio channels between the target UE and the serving anchors may also be referred to as a second set of measurement information herein. The second set of measurement information may indicate channel gain between the target UE and the first serving anchor, as well as between the target UE and the second serving anchor. For example, the second set of measurement information may comprise measured values for one or more metrics, such as received power, SNR, SINR, and/or any metric related to distance and/or signal time-of-flight. The channel gain may be a function of distance and path loss.

In step 604, the target UE transmits, or broadcasts, a positioning request message indicating a request for positioning assistance. In this exemplary embodiment, the positioning request message also comprises the second set of measurement information.

In step 605, the second candidate anchor (C2) obtains, based at least partly on the positioning request message or another transmission received from the target UE, a first set of measurement information associated with the radio channel between the target UE and the second candidate anchor. In other words, the second candidate anchor may measure the received signal comprising the positioning request message, or any other transmission, from the target UE in order to obtain the first set of measurement information. The first set of measurement information may indicate channel gain between the target UE and the second candidate anchor. For example, the first set of measurement information may comprise measured values for one or more metrics, such as received power, SNR, SINR, and/or any metric related to distance and/or signal time-of-flight.

In step 606, the first candidate anchor (C1) obtains, based at least partly on the positioning request message or another transmission received from the target UE, a fourth set of measurement information associated with the radio channel between the target UE and the first candidate anchor. In other words, the first candidate anchor may measure the received signal comprising the positioning request message, or any other transmission, from the target UE in order to obtain the fourth set of measurement information.

In step 607, the second candidate anchor determines an area based on at least the first set of measurement information (between the target UE and the second candidate anchor) and the second set of measurement information (between the target UE and the serving anchors). The determined area may be used to identify whether the second candidate anchor is a suitable (valid) candidate anchor for activation. The second candidate anchor may be a suitable (valid) candidate anchor, if it fulfils one or more geometric criteria. For example, the second candidate anchor may use hyperbolic approximation of the suitable/ideal activation sector as the geometric criterion by using a suitable version of the wrapper function, for example different scaling constants. The hyperbolic criterion may be repeated iteratively for various input parameters to identify an activation sector with higher or lower GDOP.

For example, the determined area may comprise an inclusion area with higher GDOP, wherein the inclusion area is not covered by the active serving anchors. As a non-limiting example, the second candidate anchor may be determined to be valid, if it is located inside of the intersection of all hyperboles having the serving anchors and the second candidate anchor as focal points, for example:

$${f ( H\_T : {S}_{i} )}^{2} - {f ( H\_T : {C}_{2} )}^{2} = 1 for all i and H\_T : {S}_{i} < H\_T : {C}_{2}$$

where H_T:Sᵢ is the channel gain between the target UE and the i-th serving anchor, and H_T:C₂ is the channel gain between the target UE and the second candidate anchor. A wrapper function f( ) may be used to convert channel gain to distance, for example based on an exponential path loss model H=d^{-a} for a>2, where d denotes distance. The wrapper function may alternatively represent conversion between logarithmic and linear scales.

As another example, the determined area may comprise an exclusion area with lower GDOP, wherein the exclusion area is already covered by the active serving anchors based on the second set of measurement information.

In step 608, the first candidate anchor determines an area based on at least the second set of measurement information (between the target UE and the serving anchors) and the fourth set of measurement information (between the target UE and the first candidate anchor). The determined area may be used to identify whether the first candidate anchor is a suitable (valid) candidate anchor for activation. The first candidate anchor may be a suitable (valid) candidate anchor, if it fulfils one or more geometric criteria. For example, the first candidate anchor may use hyperbolic approximation of the suitable/ideal activation sector as the geometric criterion by using a suitable version of the wrapper function, for example different scaling constants. The hyperbolic criterion may be repeated iteratively for various input parameters to identify an activation sector with higher or lower GDOP.

For example, the determined area may comprise an inclusion area with higher GDOP, wherein the inclusion area is not covered by the active serving anchors. As a non-limiting example, the second candidate anchor may be determined to be valid, if it is located inside of the intersection of all hyperboles having the serving anchors and the second candidate anchor as focal points, for example:

$${f ( H\_T : {S}_{i} )}^{2} - {f ( H\_T : {C}_{1} )}^{2} = 1 for all i and H\_T : {S}_{i} < H\_T : {C}_{1}$$

where H_T:Sᵢ is the channel gain between the target UE and the i-th serving anchor, and H_T:C₁ is the channel gain between the target UE and the first candidate anchor. A wrapper function f( ) may be used to convert channel gain to distance, for example based on an exponential path loss model H=d^{-a} for a>2, where d denotes distance. The wrapper function may alternatively represent conversion between logarithmic and linear scales.

In step 609, if the second candidate anchor determines that it is suitable for activation based on the determined area, the second candidate anchor transmits a service offer message to the target UE to accept the positioning request. The service offer message indicates that the second candidate anchor is able to provide a positioning service to the target UE.

For example, if the determined area comprises an inclusion area, then the second candidate anchor may transmit the service offer, if the second candidate anchor is inside the determined area (inclusion area).

As another example, if the determined area comprises an exclusion area, then the second candidate anchor may transmit the service, if the second candidate anchor is outside of the exclusion area.

If the first candidate anchor and/or any other candidate anchor determines that it is suitable for activation based on the determined area, then the first candidate anchor and/or the other candidate anchor may transmit a service offer message to the target UE to accept the positioning request.

Alternatively, if the first candidate anchor and/or any other candidate anchor determines that it is not suitable for activation based on the determined area, then the first candidate anchor and/or the other candidate anchor may not transmit a service offer message to the target UE. In other words, the first candidate anchor and/or the other candidate anchor may reject the positioning request in this case.

In step 610, the target UE selects a candidate anchor from the set of available candidate anchors, from which it has received a service offer message. For example, the target UE may select the second candidate anchor. If the target UE has received a service offer from multiple candidate anchors, then the target UE may, for example, randomly select one candidate anchor from the multiple candidate anchors.

As an additional criterion for the selection, the target UE may also require some minimal distance from each candidate anchor. For example, the candidate anchor may be selected based at least partly on a pre-defined range for a metric associated with the radio channel between the target UE and a given candidate anchor. The metric may be, for example, channel gain, received power, SNR, SINR, distance, time-of-flight or some other metric indicated by the first set of measurement information. As a non-limiting example, the range may be represented by a maximum limit on the channel gain between the target UE and the candidate anchor, wherein the lower limit may be zero, for example. The maximum limit for the channel gain may then be used as a subsequent criterion to narrow down the selection from the set of valid candidate anchors.

In step 611, the target UE transmits a service accepted message to the selected candidate anchor (e.g., the second candidate anchor). The service accepted message indicates the selected candidate anchor to activate its positioning service (e.g., to transmit PRS). The service accepted message may also be referred to as a second message herein.

In step 612, the selected candidate anchor activates its positioning service in response to receiving the service accepted message. In other words, the selected candidate anchor becomes the third serving anchor.

In step 613, the selected candidate anchor transmits, or broadcasts, one or more positioning reference signals upon activating the positioning service.

The target UE may then position itself based on the three active serving anchors by measuring the PRS transmitted from them.

It should be noted that at least a part of the process illustrated in FIG. 6 may be performed iteratively to activate additional serving anchors. If no suitable candidate anchors are found, then no candidate anchor may be selected and the process may end.

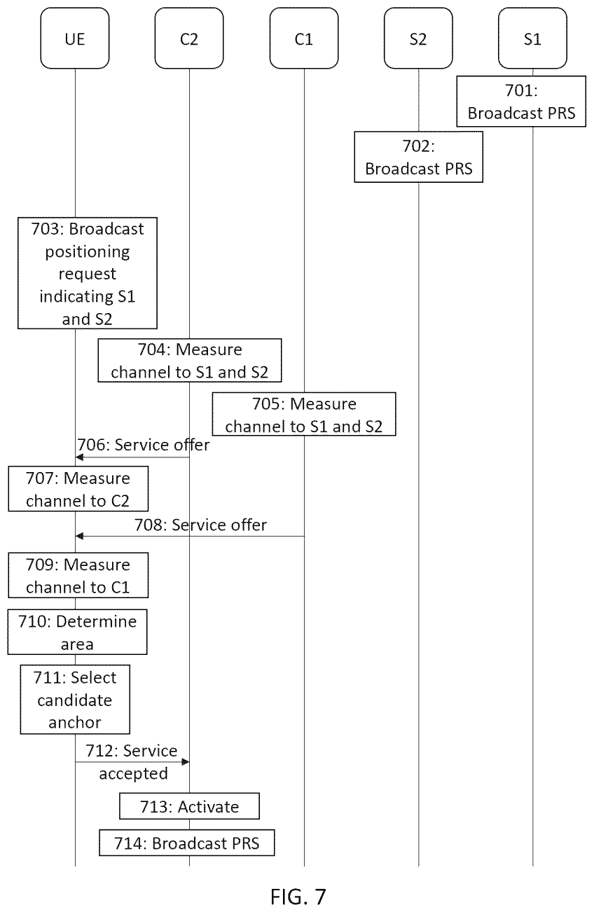

FIG. 7 illustrates a signaling diagram according to an exemplary embodiment for the candidate anchor centric approach (see FIG. 4b), where the target UE is the decision-making node. In this exemplary embodiment, the candidate anchors measure the radio channel between the candidate anchors and the serving anchors. To this end, the target UE indicates, or specifies, the serving anchors in assistance data comprised in, or attached to, the positioning request broadcast. The target UE may then select a candidate anchor based on its own measurements of the radio channel between the target UE and the candidate anchors, as well as the measurements provided by the candidate anchors.

Two serving anchors S1 and S2 and two candidate anchors C1 and C2 are illustrated as an example in FIG. 7. However, it should be noted that the number of serving anchors and the number of candidate anchors may also differ from what is shown in FIG. 7. In other words, there may be one or more serving anchors and one or more candidate anchors. The one or more serving anchors and the one or more candidate anchors may also be referred to as network nodes herein.

The two serving anchors S1 and S2 are already active in the network and keep broadcasting PRS. A third anchor is to be activated to reduce GDOP and improve positioning accuracy for positioning the target UE. Two candidate anchors C1 and C2 are available to this end.

Referring to FIG. 7, in step 701, the first serving anchor (S1) transmits, or broadcasts, one or more positioning reference signals.

In step 702, the second serving anchor (S2) transmits, or broadcasts, one or more positioning reference signals.

In step 703, the target UE transmits, or broadcasts, a positioning request message indicating a request for positioning assistance. In this exemplary embodiment, the positioning request message also indicates, or specifies, the serving anchors S1 and S2 in assistance data comprised in, or attached to, the positioning request broadcast.

In step 704, in response to receiving the positioning request broadcast, the second candidate anchor (C2) measures the one or more positioning reference signals transmitted by the first serving anchor to obtain measurement information associated with the radio channel between the second candidate anchor and the first serving anchor. Furthermore, the second candidate anchor measures the one or more positioning reference signals transmitted by the second serving anchor to obtain measurement information associated with the radio channel between the second candidate anchor and the second serving anchor.

In step 705, in response to receiving the positioning request broadcast, the first candidate anchor (C1) measures the one or more positioning reference signals transmitted by the first serving anchor to obtain measurement information associated with the radio channel between the first candidate anchor and the first serving anchor. Furthermore, the first candidate anchor measures the one or more positioning reference signals transmitted by the second serving anchor to obtain measurement information associated with the radio channel between the first candidate anchor and the second serving anchor.

The measurement information associated with the radio channels between the candidate anchors and the serving anchors may also be referred to as a third set of measurement information herein. For example, the third set of measurement information may comprise measured values for one or more metrics, such as received power, SNR, SINR, and/or any metric related to distance and/or signal time-of-flight. The channel gain may be a function of distance and path loss.

In step 706, the second candidate anchor transmits a service offer message to the target UE. The service offer message indicates that the second candidate anchor is able to provide a positioning service to the target UE. In this exemplary embodiment, the service offer message also comprises the measurement information measured by the second candidate anchor for the radio channels between the second candidate anchor and the serving anchors. The service offer message may also be referred to as a first message herein.

In step 707, the target UE obtains, based at least partly on the service offer message received from the second candidate anchor, measurement information associated with the radio channel between the target UE and the second candidate anchor. In other words, the target UE may measure the received signal comprising the service offer message from the second candidate anchor in order to obtain the measurement information for the radio channel between the target UE and the second candidate anchor.

In step 708, the first candidate anchor transmits a service offer message to the target UE. The service offer message indicates that the first candidate anchor is able to provide a positioning service to the target UE. In this exemplary embodiment, the service offer message also comprises the measurement information measured by the first candidate anchor for the radio channels between the first candidate anchor and the serving anchors. The service offer message may also be referred to as a first message herein.

In step 709, the target UE obtains, based at least partly on the service offer message received from the first candidate anchor, measurement information associated with the radio channel between the target UE and the first candidate anchor. In other words, the target UE may measure the received signal comprising the service offer message from the first candidate anchor in order to obtain the measurement information for the radio channel between the target UE and the first candidate anchor.

The measurement information associated with the radio channels between the target UE and the candidate anchors may also be referred to as a first set of measurement information herein. The first set of measurement information may indicate channel gain between the target UE and the first candidate anchor, as well as between the target UE and the second candidate anchor. For example, the first set of measurement information may comprise measured values for one or more metrics, such as received power, SNR, SINR, and/or any metric related to distance and/or signal time-of-flight. The channel gain may be a function of distance and path loss.

In step 710, the target UE determines an area based on at least the first set of measurement information (between the target UE and the candidate anchors) and the third set of measurement information (between the candidate anchors and the serving anchors). The determined area may be used to identify one or more suitable (valid) candidate anchors for activation. In other words, the one or more suitable (valid) candidate anchors may refer to candidate anchors that fulfil one or more geometric criteria.

For example, the determined area may comprise an inclusion area with higher GDOP, wherein the inclusion area is not covered by the active serving anchors.

As another example, the determined area may comprise an exclusion area with lower GDOP, wherein the exclusion area is already covered by the active serving anchors based on the third set of measurement information. As a non-limiting example, the target UE may identify one or more valid candidate anchors located outside of a union of all hyperboles having the serving anchors and the target UE as focal points, for example:

$${f ( H\_T : {C}_{j} )}^{2} - {f ( {H\_C}_{j} : {S}_{i} )}^{2} = 1 for all i and j and H\_T : {C}_{j} < {H\_C}_{j} : {S}_{i}$$

where H_T:Cⱼ is the channel gain between the target UE and the j-th candidate anchor, and H_Cⱼ:Sᵢ is the channel gain between the j-th candidate anchor and the i-th serving anchor. A wrapper function f( ) may be used to convert channel gain to distance, for example based on an exponential path loss model H=d^{-a} for a>2, where d denotes distance. The wrapper function may alternatively represent conversion between logarithmic and linear scales.

In step 711, the target UE selects, based at least partly on the determined area, a candidate anchor from the set of available candidate anchors.

For example, if the determined area comprises an inclusion area, then the target UE may select a candidate anchor that is inside the determined area (inclusion area). If multiple candidate anchors are identified to be inside the determined area (inclusion area), then the target UE may, for example, randomly select one candidate anchor from the multiple candidate anchors.

As another example, if the determined area comprises an exclusion area, then the target UE may select a candidate anchor that is outside of the exclusion area. If multiple candidate anchors are identified to be outside of the determined area (exclusion area), then the target UE may, for example, randomly select one candidate anchor from the multiple candidate anchors.

As an additional criterion for the selection, the target UE may also require some minimal distance from each candidate anchor. For example, the candidate anchor may be selected based at least partly on a pre-defined range for a metric associated with the radio channel between the target UE and a given candidate anchor. The metric may be, for example, channel gain, received power, SNR, SINR, distance, time-of-flight or some other metric indicated by the first set of measurement information. As a non-limiting example, the range may be represented by a maximum limit on the channel gain between the target UE and the candidate anchor, wherein the lower limit may be zero, for example. The maximum limit for the channel gain may then be used as a subsequent criterion to narrow down the selection from the set of valid candidate anchors.

In step 712, the target UE transmits a service accepted message to the selected candidate anchor (e.g., the second candidate anchor). The service accepted message indicates the selected candidate anchor to activate its positioning service (e.g., to transmit PRS). The service accepted message may also be referred to as a second message herein.

In step 713, the selected candidate anchor activates its positioning service in response to receiving the service accepted message. In other words, the selected candidate anchor becomes the third serving anchor.

In step 714, the selected candidate anchor transmits, or broadcasts, one or more positioning reference signals upon activating the positioning service.

The target UE may then position itself based on the three active serving anchors by measuring the PRS transmitted from them.

It should be noted that at least a part of the process illustrated in FIG. 7 may be performed iteratively to activate additional serving anchors. If no suitable candidate anchors are found, then no candidate anchor may be selected and the process may end.

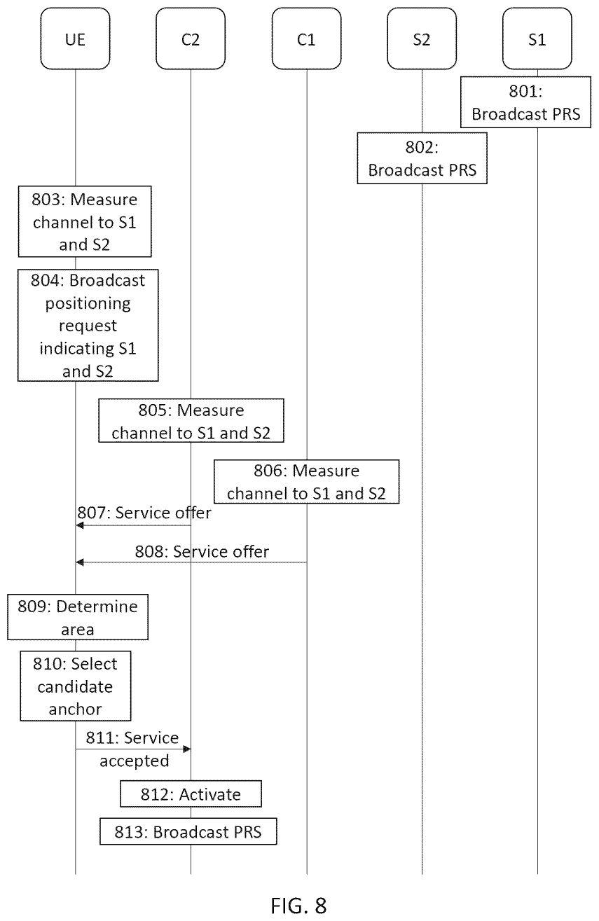

FIG. 8 illustrates a signaling diagram according to an exemplary embodiment for the serving anchor centric approach (see FIG. 4c), where the target UE is the decision-making node. In this exemplary embodiment, the candidate anchors measure the radio channel between the candidate anchors and the serving anchors. To this end, the target UE indicates, or specifies, the serving anchors in assistance data comprised in, or attached to, the positioning request broadcast. The target UE may then select a candidate anchor based on its own measurements of the radio channel between the target UE and the serving anchors, as well as the measurements provided by the candidate anchors.

Two serving anchors S1 and S2 and two candidate anchors C1 and C2 are illustrated as an example in FIG. 8. However, it should be noted that the number of serving anchors and the number of candidate anchors may also differ from what is shown in FIG. 8. In other words, there may be one or more serving anchors and one or more candidate anchors. The one or more serving anchors and the one or more candidate anchors may also be referred to as network nodes herein.

The two serving anchors S1 and S2 are already active in the network and keep broadcasting PRS. A third anchor is to be activated to reduce GDOP and improve positioning accuracy for positioning the target UE. Two candidate anchors C1 and C2 are available to this end.

Referring to FIG. 8, in step 801, the first serving anchor (S1) transmits, or broadcasts, one or more positioning reference signals.

In step 802, the second serving anchor (S2) transmits, or broadcasts, one or more positioning reference signals.

In step 803, the target UE measures the one or more positioning reference signals transmitted by the first serving anchor to obtain measurement information associated with the radio channel between the target UE and the first serving anchor. Furthermore, the target UE measures the one or more positioning reference signals transmitted by the second serving anchor to obtain measurement information associated with the radio channel between the target UE and the second serving anchor. The target UE may also position itself based on the two active serving anchors by measuring the PRS transmitted from them.

The measurement information associated with the radio channels between the target UE and the serving anchors may also be referred to as a second set of measurement information herein. The second set of measurement information may indicate channel gain between the target UE and the first serving anchor, as well as between the target UE and the second serving anchor. For example, the second set of measurement information may comprise measured values for one or more metrics, such as received power, SNR, SINR, and/or any metric related to distance and/or signal time-of-flight. The channel gain may be a function of distance and path loss.

In step 804, the target UE transmits, or broadcasts, a positioning request message indicating a request for positioning assistance. In this exemplary embodiment, the positioning request message also indicates, or specifies, the serving anchors S1 and S2 in assistance data comprised in, or attached to, the positioning request broadcast.

In step 805, in response to receiving the positioning request broadcast, the second candidate anchor (C2) measures the one or more positioning reference signals transmitted by the first serving anchor to obtain measurement information associated with the radio channel between the second candidate anchor and the first serving anchor. Furthermore, the second candidate anchor measures the one or more positioning reference signals transmitted by the second serving anchor to obtain measurement information associated with the radio channel between the second candidate anchor and the second serving anchor.

In step 806, in response to receiving the positioning request broadcast, the first candidate anchor (C1) measures the one or more positioning reference signals transmitted by the first serving anchor to obtain measurement information associated with the radio channel between the first candidate anchor and the first serving anchor. Furthermore, the first candidate anchor measures the one or more positioning reference signals transmitted by the second serving anchor to obtain measurement information associated with the radio channel between the first candidate anchor and the second serving anchor.

The measurement information associated with the radio channels between the candidate anchors and the serving anchors may also be referred to as a third set of measurement information herein. For example, the third set of measurement information may comprise measured values for one or more metrics, such as received power, SNR, SINR, and/or any metric related to distance and/or signal time-of-flight. The channel gain may be a function of distance and path loss.

In step 807, the second candidate anchor transmits a service offer message to the target UE. The service offer message indicates that the second candidate anchor is able to provide a positioning service to the target UE. In this exemplary embodiment, the service offer message also comprises the measurement information measured by the second candidate anchor for the radio channels between the second candidate anchor and the serving anchors. The service offer message may also be referred to as a first message herein.

In step 808, the first candidate anchor transmits a service offer message to the target UE. The service offer message indicates that the first candidate anchor is able to provide a positioning service to the target UE. In this exemplary embodiment, the service offer message also comprises the measurement information measured by the first candidate anchor for the radio channels between the first candidate anchor and the serving anchors. The service offer message may also be referred to as a first message herein.

In step 809, the target UE determines an area based on at least the second set of measurement information (between the target UE and the serving anchors) and the third set of measurement information (between the candidate anchors and the serving anchors). The determined area may be used to identify one or more suitable (valid) candidate anchors for activation. In other words, the one or more suitable (valid) candidate anchors may refer to candidate anchors that fulfil one or more geometric criteria.

For example, the determined area may comprise an inclusion area with higher GDOP, wherein the inclusion area is not covered by the active serving anchors.

As another example, the determined area may comprise an exclusion area with lower GDOP, wherein the exclusion area is already covered by the active serving anchors based on the second set of measurement information. As a non-limiting example, the target UE may identify one or more valid candidate anchors, for which all serving anchors are located outside of a hyperbolic area having the candidate anchors and the target UE as focal points, for example:

$${f ( H\_T : {S}_{i} )}^{2} - {f ( {H\_S}_{i} : {C}_{j} )}^{2} = 1 for all i and j and H\_T : {S}_{i} < {H\_S}_{i} : {C}_{j}$$

where H_T:Sᵢ is the channel gain between the target UE and the i-th serving anchor, and H_Sᵢ:Cⱼ is the channel gain between the i-th serving anchor and the j-th candidate anchor. A wrapper function f( ) may be used to convert channel gain to distance, for example based on an exponential path loss model H=d^{-a} for a>2, where d denotes distance. The wrapper function may alternatively represent conversion between logarithmic and linear scales.

In step 810, the target UE selects, based at least partly on the determined area, a candidate anchor from the set of available candidate anchors.

For example, if the determined area comprises an inclusion area, then the target UE may select a candidate anchor that is inside the determined area (inclusion area). If multiple candidate anchors are identified to be inside the determined area (inclusion area), then the target UE may, for example, randomly select one candidate anchor from the multiple candidate anchors.

As another example, if the determined area comprises an exclusion area, then the target UE may select a candidate anchor that is outside of the exclusion area. If multiple candidate anchors are identified to be outside of the exclusion area, then the target UE may, for example, randomly select one candidate anchor from the multiple candidate anchors.

As an additional criterion for the selection, the target UE may also require some minimal distance from each candidate anchor. For example, the candidate anchor may be selected based at least partly on a pre-defined range for a metric associated with the radio channel between the target UE and a given candidate anchor. The metric may be, for example, channel gain, received power, SNR, SINR, distance, time-of-flight or some other metric indicated by the first set of measurement information. As a non-limiting example, the range may be represented by a maximum limit on the channel gain between the target UE and the candidate anchor, wherein the lower limit may be zero, for example. The maximum limit for the channel gain may then be used as a subsequent criterion to narrow down the selection from the set of valid candidate anchors.

In step 811, the target UE transmits a service accepted message to the selected candidate anchor (e.g., the second candidate anchor). The service accepted message indicates the selected candidate anchor to activate its positioning service (e.g., to transmit PRS). The service accepted message may also be referred to as a second message herein.

In step 812, the selected candidate anchor activates its positioning service in response to receiving the service accepted message. In other words, the selected candidate anchor becomes the third serving anchor.

In step 813, the selected candidate anchor transmits, or broadcasts, one or more positioning reference signals upon activating the positioning service.

The target UE may then position itself based on the three active serving anchors by measuring the PRS transmitted from them.

It should be noted that at least a part of the process illustrated in FIG. 8 may be performed iteratively to activate additional serving anchors. If no suitable candidate anchors are found, then no candidate anchor may be selected and the process may end.

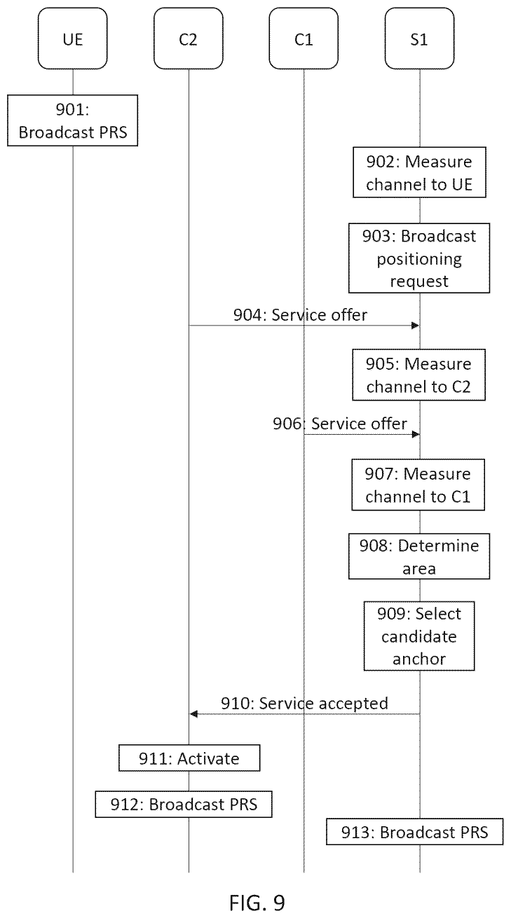

FIG. 9 illustrates a signaling diagram according to another exemplary embodiment for the serving anchor centric approach (see FIG. 4c), where a serving anchor is the decision-making node. In this exemplary embodiment, the serving anchor measure the radio channel between the serving anchor and the target UE, as well as the radio channel between the serving anchor and the candidate anchors. To this end, the target UE indicates, or specifies, the serving anchors in assistance data comprised in, or attached to, the positioning request broadcast. The target UE may then select a candidate anchor based on its own measurements of the radio channel between the target UE and the serving anchors, as well as the measurements provided by the candidate anchors.

At least one serving anchors S1 and two candidate anchors C1 and C2 are illustrated as an example in FIG. 9. However, it should be noted that the number of serving anchors and the number of candidate anchors may also differ from what is shown in FIG. 9. In other words, there may be one or more serving anchors and one or more candidate anchors. The one or more serving anchors and the one or more candidate anchors may also be referred to as network nodes herein.

The at least one serving anchor S1 is already active in the network. An additional anchor is to be activated to reduce GDOP and improve positioning accuracy for positioning the target UE. Two candidate anchors C1 and C2 are available to this end.

Referring to FIG. 9, in step 901, the target UE transmits, or broadcasts, one or more positioning reference signals, such as one or more sounding reference signals.

In step 902, the serving anchor measures the one or more positioning reference signals transmitted by the target UE to obtain measurement information associated with the radio channel between the target UE and the serving anchor.

The measurement information associated with the radio channel between the target UE and the serving anchor may also be referred to as a second set of measurement information herein. The second set of measurement information may indicate channel gain between the target UE and the serving anchor. For example, the second set of measurement information may comprise measured values for one or more metrics, such as received power, SNR, SINR, and/or any metric related to distance and/or signal time-of-flight. The channel gain may be a function of distance and path loss.

In step 903, the serving anchor transmits, or broadcasts, a positioning request message indicating a request for positioning assistance.

In step 904, the second candidate anchor (C2) transmits a service offer message to the serving anchor in response to receiving the positioning request message. The service offer message indicates that the second candidate anchor is able to provide a positioning service to the target UE. Alternatively, instead of an explicit service offer message, the second candidate anchor may transmit some other message, for example a set of measurements, that implicitly indicates that the second candidate anchor is able to provide the positioning service. The service offer message or the implicit message may also be referred to as a first message herein.

In step 905, the serving anchor obtains, based at least partly on the first message received from the second candidate anchor, measurement information associated with the radio channel between the serving anchor and the second candidate anchor. In other words, the serving anchor may measure the received signal comprising the first message from the second candidate anchor in order to obtain the measurement information.

Alternatively, the serving anchor may obtain the measurement information based on one or more positioning reference signals previously transmitted by the second candidate anchor.

In step 906, the first candidate anchor (C1) transmits a service offer message to the serving anchor in response to receiving the positioning request message. The service offer message indicates that the second candidate anchor is able to provide a positioning service to the target UE. Alternatively, instead of an explicit service offer message, the first candidate anchor may transmit some other message, for example a set of measurements, that implicitly indicates that the first candidate anchor is able to provide the positioning service. The service offer message or the implicit message may also be referred to as a first message herein.

In step 907, the serving anchor obtains, based at least partly on the first message received from the first candidate anchor, measurement information associated with the radio channel between the serving anchor and the first candidate anchor. In other words, the serving anchor may measure the received signal comprising the first message from the first candidate anchor in order to obtain the measurement information.

Alternatively, the serving anchor may obtain the measurement information based on one or more positioning reference signals previously transmitted by the first candidate anchor.

The measurement information associated with the radio channels between the serving anchor and the candidate anchors may also be referred to as a third set of measurement information herein. The third set of measurement information may indicate channel gain between the serving anchor and the first candidate anchor, as well as between the serving anchor and the second candidate anchor. For example, the third set of measurement information may comprise measured values for one or more metrics, such as received power, SNR, SINR, and/or any metric related to distance and/or signal time-of-flight. The channel gain may be a function of distance and path loss.

In step 908, the serving anchor determines an area based on at least the second set of measurement information (between the serving anchor and the target UE) and the third set of measurement information (between the serving anchor and the candidate anchors). The determined area may be used to identify one or more suitable (valid) candidate anchors for activation. In other words, the one or more suitable (valid) candidate anchors may refer to candidate anchors that fulfil one or more geometric criteria.

For example, the determined area may comprise an inclusion area with higher GDOP, wherein the inclusion area is not covered by the active serving anchors.

As another example, the determined area may comprise an exclusion area with lower GDOP, wherein the exclusion area is already covered by the active serving anchors.

In step 909, the serving anchor selects, based at least partly on the determined area, a candidate anchor from the set of available candidate anchors.

For example, if the determined area comprises an inclusion area, then the serving anchor may select a candidate anchor that is inside the determined area (inclusion area). If multiple candidate anchors are identified to be inside the determined area (inclusion area), then the serving anchor may, for example, randomly select one candidate anchor from the multiple candidate anchors.

As another example, if the determined area comprises an exclusion area, then the serving anchor may select a candidate anchor that is outside of the exclusion area. If multiple candidate anchors are identified to be outside of the exclusion area, then the serving anchor may, for example, randomly select one candidate anchor from the multiple candidate anchors.

In step 910, the serving anchor transmits a service accepted message to the selected candidate anchor (e.g., the second candidate anchor). The service accepted message indicates the selected candidate anchor to activate its positioning service (e.g., to transmit PRS). The service accepted message may also be referred to as a second message herein.

In step 911, the selected candidate anchor activates its positioning service in response to receiving the service accepted message. In other words, the selected candidate anchor becomes a serving anchor.

In step 912, the selected candidate anchor transmits, or broadcasts, one or more positioning reference signals upon activating the positioning service.

In step 913, the serving anchor may transmit, or broadcast, one or more positioning reference signals.

The target UE may then position itself based on the active serving anchors by measuring the PRS transmitted from them.

It should be noted that at least a part of the process illustrated in FIG. 9 may be performed iteratively to activate additional serving anchors. If no suitable candidate anchors are found, then no candidate anchor may be selected and the process may end.

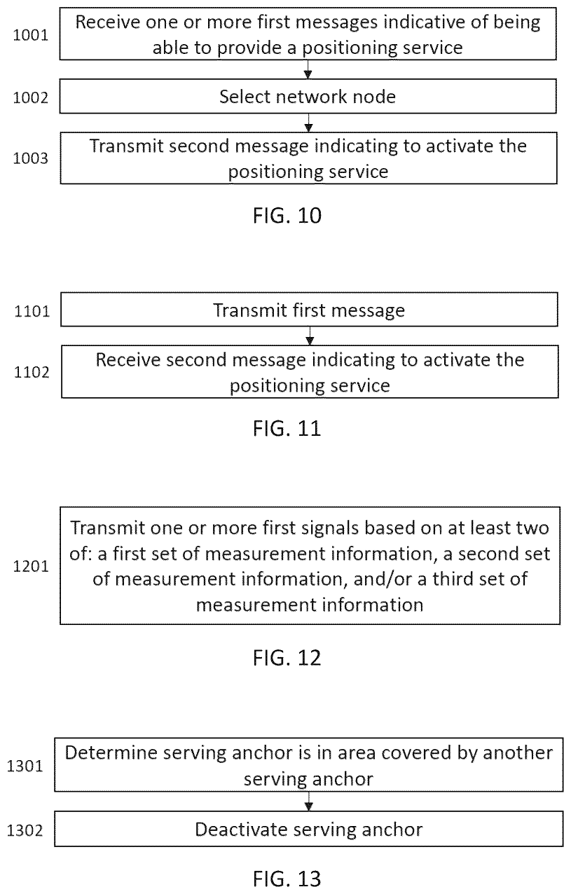

FIG. 10 illustrates a flow chart according to another exemplary embodiment. The steps illustrated in FIG. 10 may be performed by an apparatus such as, or comprised in, a UE (e.g., the target UE of FIGS. 5-8) or a network node (e.g., the serving anchor of FIG. 9).

Referring to FIG. 10, in step 1001, one or more first messages are received from one or more network nodes, wherein the one or more first messages are indicative of the one or more network nodes being able to provide a positioning service. In other words, one first message may be received per network node, and a given first message may be indicative of a given network node being able to provide the positioning service. The one or more network nodes may comprise one or more candidate anchors and/or one or more serving anchors.

In step 1002, a network node from the one or more network nodes is selected based at least partly on the one or more first messages.

For example, the apparatus may measure the signals comprising the one or more first messages, and use these measurements for making the selection. Alternatively, or additionally, the one or more first messages may comprise measurement information provided by the one or more network nodes, and the apparatus may use this measurement information for making the selection.

In step 1003, a second message is transmitted to the selected network node, wherein the second message indicates to activate the positioning service at the selected network node.

FIG. 11 illustrates a flow chart according to another exemplary embodiment. The steps illustrated in FIG. 11 may be performed by an apparatus such as, or comprised in, a network node (e.g., the second candidate anchor of FIGS. 5-9).

Referring to FIG. 11, in step 1101, a first message is transmitted to a target UE or a serving anchor of the target UE, wherein the first message is indicative of the apparatus being able to provide a positioning service. The first message may comprise measurement information associated with a radio channel between the apparatus and the serving anchor.

In step 1102, a second message is received from the target UE or the serving anchor, wherein the second message indicates to activate the positioning service at the apparatus. The second message may be received in response to transmitting the first message.

FIG. 12 illustrates a flow chart according to an exemplary embodiment. The steps illustrated in FIG. 12 may be performed by an apparatus such as, or comprised in, a network node (e.g., candidate anchor and/or serving anchor of FIGS. 5-9). In this exemplary embodiment, the network node may start broadcasting PRS immediately after it deems itself suitable/useful. Any other potential network nodes (e.g., candidate anchors) may back off once they hear the new anchor transmitting. In other words, the separate activation message of the above exemplary embodiments may be optional.

Referring to FIG. 12, in step 1201, the apparatus transmits one or more first signals based on at least two of: a first set of measurement information associated with a radio channel between the apparatus and a terminal device, a second set of measurement information associated with a radio channel between the terminal device and one or more serving anchors of the terminal device, and/or a third set of measurement information associated with a radio channel between the apparatus and the one or more serving anchors. For example, the apparatus may determine an area, such as an inclusion area or an exclusion area, based on at least two sets of measurement information, and decide to transmit the one or more first signals, if the apparatus is inside the inclusion area or outside of the exclusion area.

The one or more first signals may comprise, for example, one or more positioning reference signals. Alternatively, if a separate activation message is used, the one or more first signals may comprise a first message, for example a service offer message, indicative of the apparatus being able to provide a positioning service to a target UE.

Some exemplary embodiments may also be performed in a reverse manner to deactivate one or more serving anchors, for example in case too many serving anchors are used and/or some of the serving anchors duplicate each other's positioning service. This is illustrated in FIG. 13.

FIG. 13 illustrates a flow chart according to an exemplary embodiment for deactivating a serving anchor that is determined to not be useful. The steps illustrated in FIG. 13 may be performed by an apparatus such as, or comprised in, a UE (e.g., the target UE of FIGS. 5-8) or a network node (e.g., a serving anchor of the UE).

Referring to FIG. 13, in step 1301, it is determined that a first serving anchor is in an area covered by a second serving anchor. In other words, the first serving anchor duplicates the positioning service provided by the second serving anchor, and thus the first serving anchor provides little or no benefit in positioning the target UE. The determination may be performed, for example, based on measurement information associated with the radio channels between the target UE and the serving anchors, and the radio channel between the first serving anchor and the second serving anchor.

In step 1302, the first serving anchor is deactivated. For example, if the apparatus is the target UE or the second serving anchor, then the apparatus may transmit a message to the first serving anchor indicating to deactivate the positioning service at the first serving anchor. This message may also be referred to as a third message herein. The first serving anchor may then deactivate its positioning service and stop transmitting PRS upon receiving the message.

Alternatively, if the apparatus is the first serving anchor itself, then the first serving anchor may deactivate its positioning service based on the determination made by itself in step 1301 (i.e., without receiving any deactivation message from another node).

The steps and/or blocks described above by means of FIGS. 5-13 are in no absolute chronological order, and some of them may be performed simultaneously or in an order differing from the described one. Other steps and/or blocks may also be executed between them or within them.

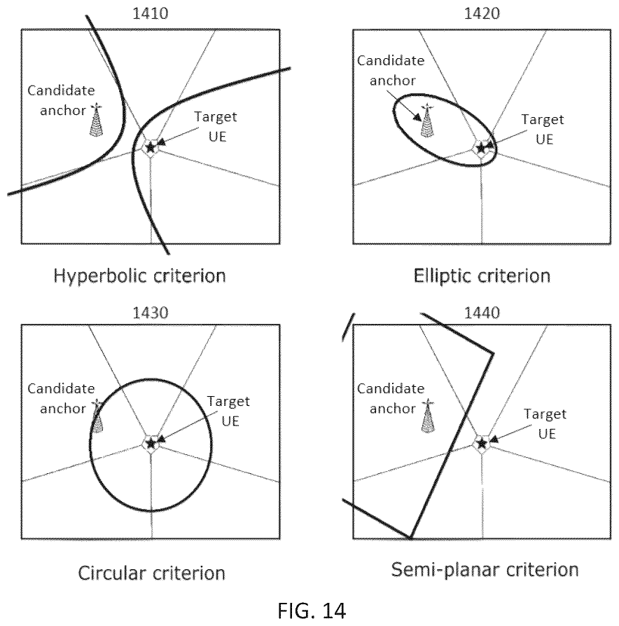

FIG. 14 illustrates examples of possible geometric transformations of channel measurements performed by a candidate anchor. The geometric criteria for anchor activation may comprise one or more of the following: a hyperbolic criterion, an elliptic criterion, a circular criterion, and/or a semi-planar criterion.

Block 1410 of FIG. 14 illustrates a hyperbolic criterion:

$$f ( H\_Si : T ) ⋀ 2 f ( H\_Cj : Si ) ⋀ 2 < 1$$

Block 1420 of FIG. 14 illustrates an elliptic criterion:

$$f ( H\_Si : T ) ⋀ 2 + f ( H\_Cj : Si ) ⋀ 2 < 1$$

Block 1430 of FIG. 14 illustrates a circular criterion:

$$H\_Cj : T < H\_max , H\_Si : T < H\_max$$

Block 1440 of FIG. 14 illustrates a semi-planar criterion:

$$H\_Cj : T > H\_Si : T$$

H_max is a pre-defined maximum limit for channel gain, and f( ) is a wrapper function f(*) as described above.

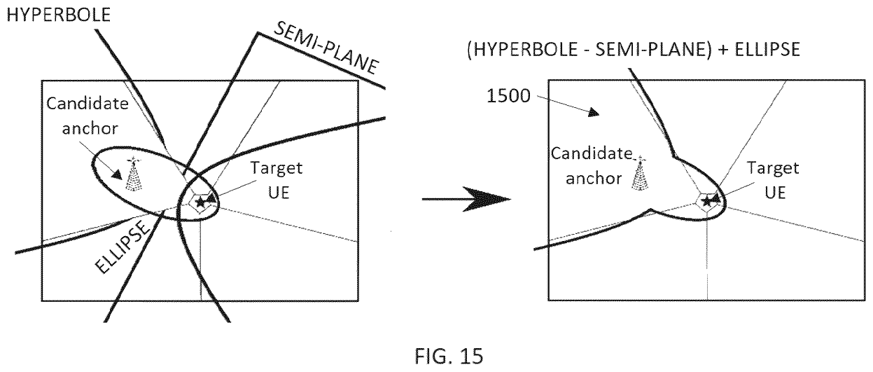

FIG. 15 illustrates an example of combining multiple geometric criteria to produce more accurate estimates of the ideal or suitable sector 1500 for anchor activation. By combining multiple geometric criteria, the ideal or suitable sector 1500 for anchor activation can be approximated more accurately. FIG. 15 shows how three criteria (hyperbolic, elliptic and semi-planar) are combined as:

$$( HYPERBOLE - SEMI - PLANE ) + ELLIPSE$$

to produce a more accurate approximation of the ideal or suitable sector 1500.

The following logic can then be used to decide on the activation of a given candidate anchor:

```
  IF
  [(HYPERBOLE − SEMI_PLANE) + ELLIPSE] is TRUE
THEN
    “accept positioning request from target UE”
  ELSE
    “reject positioning request from target UE”
  END
```

The decision-making node may also decide the type of geometric criterion depending on the number of active serving anchors Sᵢ. For a lower number, a coarser semi-plane criterion may be used. For a higher number, a more accurate hyperbolic criterion may be used. For more accurate results, combined criteria may be used.

A technical advantage provided by some exemplary embodiments is that they may enable fast and efficient selection of one or more suitable candidate anchors for improving the positioning accuracy of a target UE without additional signaling overhead. The activation of duplicate anchors in co-located or poorly separated positions with regard to the existing serving anchors may be avoided. Some exemplary embodiments require no prior topology knowledge or directive antenna measurements.

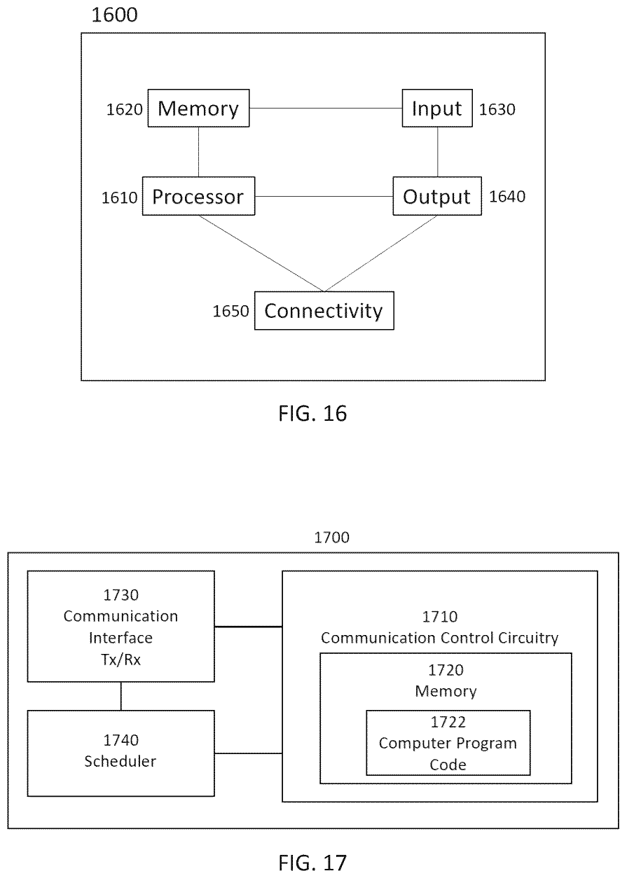

FIG. 16 illustrates an apparatus 1600, which may be an apparatus such as, or comprised in, a terminal device, according to an exemplary embodiment. The terminal device may also be called a subscriber unit, mobile station, remote terminal, access terminal, user terminal, user device, user equipment (UE), target UE, candidate anchor, serving anchor, or network node herein. The apparatus 1600 comprises a processor 1610. The processor 1610 interprets computer program instructions and processes data. The processor 1610 may comprise one or more programmable processors. The processor 1610 may comprise programmable hardware with embedded firmware and may, alternatively or additionally, comprise one or more application-specific integrated circuits (ASICs).

The processor 1610 is coupled to a memory 1620. The processor is configured to read and write data to and from the memory 1620. The memory 1620 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1620 stores computer readable instructions that are executed by the processor 1610. For example, non-volatile memory stores the computer readable instructions, and the processor 1610 executes the instructions using volatile memory for temporary storage of data and/or instructions.

The computer readable instructions may have been pre-stored to the memory 1620 or, alternatively or additionally, they may be received, by the apparatus, via an electromagnetic carrier signal and/or may be copied from a physical entity such as a computer program product. Execution of the computer readable instructions causes the apparatus 1600 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 1600 may further comprise, or be connected to, an input unit 1630. The input unit 1630 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1630 may comprise an interface to which external devices may connect to.

The apparatus 1600 may also comprise an output unit 1640. The output unit may comprise or be connected to one or more displays capable of rendering visual content, such as a light emitting diode (LED) display, a liquid crystal display (LCD) and/or a liquid crystal on silicon (LCoS) display. The output unit 1640 may further comprise one or more audio outputs. The one or more audio outputs may be for example loudspeakers.

The apparatus 1600 further comprises a connectivity unit 1650. The connectivity unit 1650 enables wireless connectivity to one or more external devices. The connectivity unit 1650 comprises at least one transmitter and at least one receiver that may be integrated to the apparatus 1600 or that the apparatus 1600 may be connected to. The at least one transmitter comprises at least one transmission antenna, and the at least one receiver comprises at least one receiving antenna. The connectivity unit 1650 may comprise an integrated circuit or a set of integrated circuits that provide the wireless communication capability for the apparatus 1600. Alternatively, the wireless connectivity may be a hardwired application-specific integrated circuit (ASIC). The connectivity unit 1650 may comprise one or more components such as a power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 1600 may further comprise various components not illustrated in FIG. 16. The various components may be hardware components and/or software components.

The apparatus 1700 of FIG. 17 illustrates an exemplary embodiment of an apparatus such as, or comprised in, an access node of a wireless communication network. The access node may also be referred to, for example, as a serving anchor, a candidate anchor, a network element, a RAN node, a NodeB, an eNB, a gNB, a base station, an NR base station, a 5G base station, a network node, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1700 may comprise, for example, a circuitry or a chipset applicable for realizing some of the described exemplary embodiments. The apparatus 1700 may be an electronic device comprising one or more electronic circuitries. The apparatus 1700 may comprise a communication control circuitry 1710 such as at least one processor, and at least one memory 1720 storing instructions that, when executed by the at least one processor, cause the apparatus 1700 to carry out some of the exemplary embodiments described above. Such instructions may, for example, include a computer program code (software) 1722 wherein the at least one memory and the computer program code (software) 1722 are configured, with the at least one processor, to cause the apparatus 1700 to carry out some of the exemplary embodiments described above. Herein computer program code may in turn refer to instructions that cause the apparatus 1700 to perform some of the exemplary embodiments described above. That is, the at least one processor and the at least one memory 1720 storing the instructions may cause said performance of the apparatus.

The processor is coupled to the memory 1720. The processor is configured to read and write data to and from the memory 1720. The memory 1720 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1720 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 1720 or, alternatively or additionally, they may be received, by the apparatus, via an electromagnetic carrier signal and/or may be copied from a physical entity such as a computer program product. Execution of the computer readable instructions causes the apparatus 1700 to perform one or more of the functionalities described above.

The memory 1720 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some exemplary embodiments, structures of the frames used in the detected neighbour cells.

The apparatus 1700 may further comprise a communication interface 1730 comprising hardware and/or software for realizing communication connectivity according to one or more communication protocols. The communication interface 1730 comprises at least one transmitter (Tx) and at least one receiver (Rx) that may be integrated to the apparatus 1700 or that the apparatus 1700 may be connected to. The communication interface 1730 provides the apparatus with radio communication capabilities to communicate in the cellular communication system. The communication interface may, for example, provide a radio interface to one or more terminal devices. The apparatus 1700 may further comprise another interface towards a core network such as the network coordinator apparatus and/or to the access nodes of the cellular communication system. The apparatus 1700 may further comprise a scheduler 1740 that is configured to allocate resources. The scheduler 1740 may be configured along with the communication control circuitry 1710 or it may be separately configured.

It is to be noted that the apparatus 1700 may further comprise various components not illustrated in FIG. 17. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s)), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1. A target user equipment (UE) comprising at least one processor, and at least one memory including computer program code, wherein the at least one memory and the computer program code are configured, with the at least one processor, to cause the target UE to:
transmit, to plural UEs, a positioning request message indicating a request for positioning assistance;
receive, from one or more of the plural UEs, one or more first messages indicative of being able to provide a positioning service in response to the positioning request message;
select, based at least partly on the one or more first messages, a UE from the one or more UEs;
transmit, to the selected UE, a second message indicating to activate the positioning service; and
receive one or more positioning reference signals from the selected UE, which has activated the positioning service in response to transmitting the second message.

2. (canceled)

3. The target UE according to claim 1, wherein the one or more UEs comprise one or more candidate anchors and one or more serving anchors.

4. The target UE according to claim 3, wherein the selected UE is selected based on at least one of: a first set of measurement information associated with a radio channel between the target UE and the one or more candidate anchors, a second set of measurement information associated with a radio channel between the target UE and the one or more serving anchors, and/or a third set of measurement information associated with a radio channel between the one or more UEs.

5. The target UE according to claim 4, wherein the target UE is further caused to:
determine an area based on at least two of: the first set of measurement information, the second set of measurement information, and/or the third set of measurement information,
wherein the selected UE is selected based at least partly on the determined area.

6. The target UE according to claim 4, wherein the target UE is further caused to:
receive one or more signals from the one or more serving anchors; and
measure the one or more signals received from the one or more serving anchors to obtain the second set of measurement information.

7. The target UE according to claim 6, wherein the target UE is further caused to:
transmit the positioning request message comprising at least the second set of measurement information.

8. A method comprising:
transmitting, to plural UEs, a positioning request message indicating a request for positioning assistance;
receiving, by a target user equipment (UE) from one or more of the plural UEs, one or more first messages indicative of being able to provide a positioning service in response to the positioning request message;
selecting, by the target UE based at least partly on the one or more first messages, a UE from the one or more UEs;
transmitting, by the target UE to the selected UE, a second message indicating to activate the positioning service; and
receiving one or more positioning reference signals from the selected UE, which has activated the positioning service in response to the second message.

9. (canceled)

10. The method according to claim 8, wherein the one or more UEs comprise one or more candidate anchors and one or more serving anchors.

11. The method according to claim 10, wherein the selected UE is selected based on at least one of: a first set of measurement information associated with a radio channel between the target UE and the one or more candidate anchors, a second set of measurement information associated with a radio channel between the target UE and the one or more serving anchors, and/or a third set of measurement information associated with a radio channel between the one or more UEs.

12. The method according to claim 11, further comprising:
determining an area based on at least two of: the first set of measurement information, the second set of measurement information, and/or the third set of measurement information,
wherein the selected UE is selected based at least partly on the determined area.

13. The method according to claim 11, further comprising:
receiving one or more signals from the one or more serving anchors; and
measuring the one or more signals received from the one or more serving anchors to obtain the second set of measurement information.

14. The method according to claim 13, further comprising:
transmitting the positioning request message comprising at least the second set of measurement information.

15. A non-transitory computer readable medium comprising instructions for causing a target user equipment (UE) to perform at least the following:
transmitting, to plural UEs, a positioning request message indicating a request for positioning assistance;
receiving, from one or more of the plural UEs, one or more first messages indicative of being able to provide a positioning service in response to the positioning request message:
selecting, based at least partly on the one or more first messages, a UE from the one or more UEs:
transmitting, to the selected UE, a second message indicating to activate the positioning service; and
receiving one or more positioning reference signals from the selected UE, which has activated the positioning service in response to the second message.

16. (canceled)

17. The non-transitory computer readable medium according to claim 15, wherein the one or more UEs comprise one or more candidate anchors and one or more serving anchors.

18. The non-transitory computer readable medium according to claim 17, wherein the selected UE is selected based on at least one of: a first set of measurement information associated with a radio channel between the target UE and the one or more candidate anchors, a second set of measurement information associated with a radio channel between the target UE and the one or more serving anchors, and/or a third set of measurement information associated with a radio channel between the one or more UEs.

19. The non-transitory computer readable medium according to claim 18, wherein the target UE is further caused to:
determine an area based on at least two of: the first set of measurement information, the second set of measurement information, and/or the third set of measurement information,
wherein the selected UE is selected based at least partly on the determined area.

20. The non-transitory computer readable medium according to claim 19, further comprising instructions to cause the target UE to perform:
receive one or more signals from the one or more serving anchors; and
measure the one or more signals received from the one or more serving anchors to obtain the second set of measurement information.
